(19) United States
(12) Patent Application Publication
(10) Pub. No.: US 2023/0059298 A1
(43) Pub. Date: Feb. 23, 2023

(54) CAVITATION DETECTION SYSTEM AND METHOD

(71) Applicant: CHEVRON U.S.A. INC., San Ramon, CA (US)

(72) Inventor: Michael Jon Beerman, Spring, TX (US)

(21) Appl. No.: 17/820,537

(22) Filed: Aug. 17, 2022

Related U.S. Application Data
(60) Provisional application No. 63/234,324, filed on Aug. 18, 2021.

(51) Int. Cl. G01M 99/00

(52) U.S. Cl. CPC G01M 99/005

(57) ABSTRACT

Cavitation detection systems and methods may include receiving sensor data from one or more data sources; translating a first format of the sensor data to a second format of the sensor data; transmitting the second format of the sensor data; receiving one or more requests for the second format of the sensor data; transmitting one or more responses that are responsive to the one or more requests; and triggering one or more actions based on the one or more responses.

### FIELD OF THE INVENTION

The present invention relates generally to a cavitation detection device. More specifically, the present invention relates to a cavitation detection device using a wireless acoustic sensor.

### BACKGROUND ART

Cavitation of liquid flows caused by operational conditions may cause damage as vapor bubbles collapse. Moreover, commercially available detection devices require pressure sensors that are installed in or on process piping, and then wired back to control cabinets. Numerous examples in literature explain how to use vibration and acoustics to predict the onset of cavitation, but no wireless cavitation sensors using acoustics as described herein are disclosed. These and other deficiencies exist.

### SUMMARY OF THE INVENTION

Embodiments of the present disclosure provide a cavitation detection system including one or more processors. The one or more processors may be configured to receive sensor data from one or more data sources. The one or more processors may be configured to translate a first format of the sensor data to a second format of the sensor data. The one or more processors may be configured to transmit the second format of the sensor data. The one or more processors may be configured to receive one or more requests for the second format of the sensor data. The one or more processors may be configured to transmit one or more responses that are responsive to the one or more requests. The one or more processors may be configured to trigger one or more actions based on the one or more responses.

Embodiments of the present disclosure provide a method of cavitation detection. The method may include receiving sensor data from one or more data sources. The method may include translating a first format of the sensor data to a second format of the sensor data. The method may include transmitting the second format of the sensor data. The method may include receiving one or more requests for the second format of the sensor data. The method may include transmitting one or more responses that are responsive to the one or more requests. The method may include triggering one or more actions based on the one or more responses.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts a cavitation detection system according to an exemplary embodiment.

FIG. 2 depicts a method of cavitation detection according to an exemplary embodiment.

FIG. 3 depicts a block diagram of a cavitation sensor 300 according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The systems and methods disclosed herein are directed to cavitation detection, and alerting on cavitation using acoustic sensors to avoid prolonged exposure and damage to equipment. The sensor may be magnetically coupled to the equipment. Moreover, the sensor may be installed on one or more pumps and sensor data feeds connected to one or more data historians. In this manner, the cavitation detection rating may be highlighted such that one or more operational conditions may be adjusted to prevent further damage to the one or more pumps and/or other equipment. Since cavitation often leads to bearing and seal failures, early identification of cavitation may extend the life span of pumps from five years to ten years. For example, a typical repair of a small pump may cost around $15,000 and cavitation detection as described herein would reduce the annualized repair cost from $3,000 to $1,500. Depending on the number and types of pumps at a given site or location, this can yield a potential annual savings of about $1.5 million.

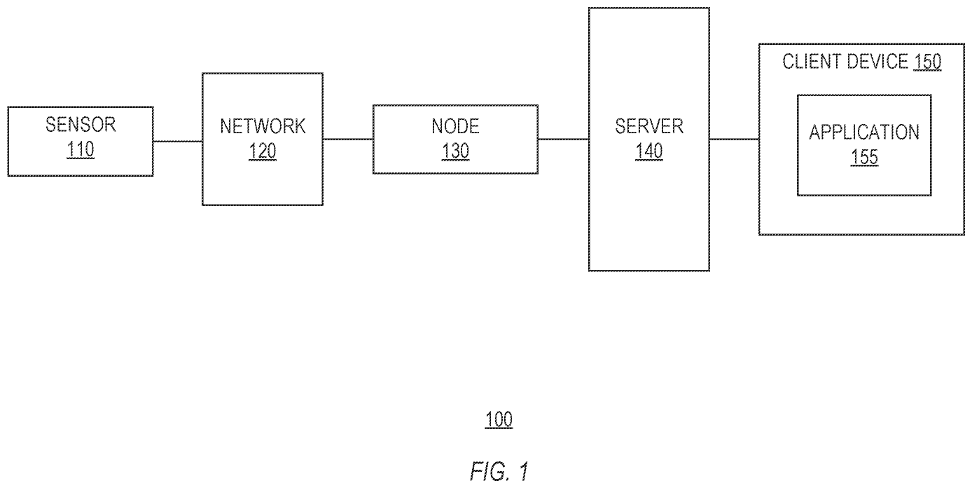

FIG. 1 depicts a cavitation detection system 100. System 100 may include a sensor 110, a network 120, a node 130, a server 140, and a client device 150. Although FIG. 1 illustrates single instances of components of system 100, system 100 may include any number of components. In addition to the acoustic readings from one or more sensors 110, vibration readings from one or more sensors 110 may be used to enhance the determination of cavitation. Moreover, readings from other types of sensors, including but not limited to pressure, flow rate, machinery speed, and/or valve position, may be compared to the acoustic data, vibration data, and/or any combination thereof, to determine cavitation since these readings all relate to the cavitation phenomena and strength.

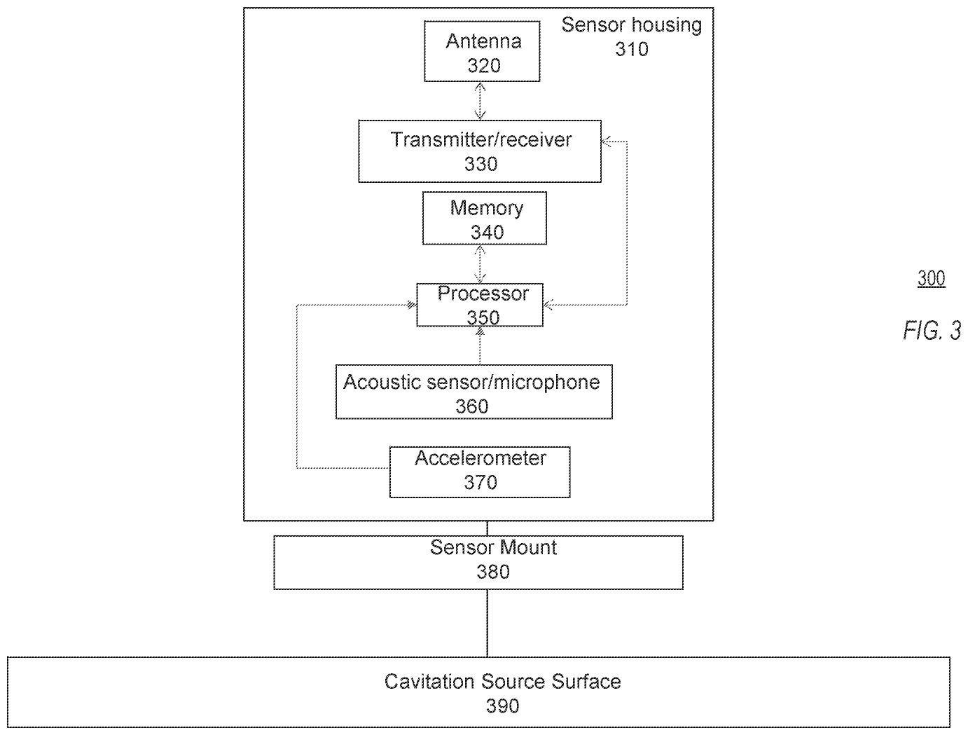

The sensor 110 may include a wireless acoustic sensor, as further illustrated in FIG. 3. The sensor 110 may be mounted to equipment. For example, the sensor 110 may be installed on one or more pumps, such as a centrifugal pump, since these pumps make up the largest volume of pumps in the industry and are the most prone to cavitation damage. The sensor 110 may also be installed on one or more valves, such as a control valve since these valves make up the next largest type of equipment prone to cavitation damage, as a regulating valve may cause extremely low pressures in its internals thereby causing damage to those internals and the piping just downstream of the valve. The sensor 110 may be configured to record a sound waveform. In some examples, the sensor 110 may be configured to record the sound waveform on a predetermined basis. For example, the sensor 110 may be configured to record the waveform on a periodic basis. The sensor 110 may be configured to report on each recording of the sound waveform. The sensor 110 may be configured to report on a specified time period that exceeds the time between each reading. The sensor 110 may be configured to report on the specified time period unless cavitation is detected, at which point the sensor 110 may be configured to report immediately in real-time. The sensor data may be analyzed to determine one or more automated corrective actions resulting from the detection of probability of cavitation. For example, such corrective actions may be taken by system 100 include validating that cavitation is actually taking place, via the systems and methods described herein, and rectifying the cavitation by increasing the flow rate, increasing the suction pressure, increasing the discharge pressure, and/or any combination thereof. These adjustments may serve as the nexus between the corrective action and cavitation detection probability, and depend on the type of pump or valve at issue. Additionally, responsive to the detection of probability of cavitation, one or more backup pumps and/or valves may be configured to control, via machine learning by system 100, redirect flow, increase flow, discharge pressure, and/or any combination thereof.

The sensor 110 may be magnetically coupled to the equipment. For example, a magnet may be secured, including but not limited to via one or more screws, to a portion of the sensor 110, such as a base portion of the sensor 110. Consequently, this arrangement may enable the sensor 110 to be positioned on any ferromagnetic type of equipment, such as motor, pump housing, and/or piping. The placement of the sensor 110 may be on a surface of the equipment, such as on a surface in proximity to the inlet of the pump. Other sensor coupling techniques may be used, such as epoxy coupling. Moreover, the sensor 110 may be configured to remove ambient noise. In some examples, noise may be removed based on readings from two sensors 110, and subtracting one of the readings by one of the sensors from the reading by the other sensor. In other examples, noise may be removed based on a reading recorded from a predetermined time when the equipment is known and confirmed to be operating in a healthy state, and then subtracted from one or more future readings.

The sound waveform may be processed via a plurality of passes. A first pass may be selected from the plurality of passes and may be associated with decibel level. A second pass may be selected from the plurality of passes and may be associated with frequency amplitude.

The first pass may include evaluation of the overall decibel reading at normal flow rates for the sensor baseline data. In some examples, normal flow rates may be those congruent with the design flow rate and pressures using the design fluid. The sensor baseline data would also be confirmed by the node 130, server 140, or application 155 of the device 150 configured to analyze the acoustics of cavitation in the equipment. An alert margin may be set a fixed percentage above this baseline to be used as an alert of cavitation. For example, a first type of cavitation detection probability, such as low cavitation detection probability, may be at 5 decibels rise, and a second type of cavitation detection probability, such as high cavitation detection probability, may be at 10 decibels rise. Accordingly, each type of cavitation detection probability is be associated with a different threshold decibel rise.

Moreover, each type of cavitation detection probability, for example, low cavitation detection probability may trigger a first type of alert whereas the second or high cavitation detection probability may trigger a second type of alert. Different alerts may be generated upon determination of the cavitation detection probability. The different alerts may be configured to correspond to different alarm levels, such as via a color coded scheme, a character/number scheme, and/or any combination thereof. In some examples, the different alarm levels may include cavitation probability value. Without limitation, a first value, such as 0, may indicate no cavitation detection, a second value, such as 1, may indicate a low level cavitation detection, and a third value, such as 2, may indicate a high level cavitation detection. Each of these values may be generated and/or retrieved from any component of system 100, such as the server 140, and any color or combination of colors may be assigned by any component of system 100 to each of these values. For example, a plurality of alarm levels may be associated with one or more colors. Without limitation, a first alarm level may be associated with a first color, such as green, a second alarm level may be associated with a second color, such as yellow, and a third alarm level may be associated with a third color, such as red. It is understood that other colors and combinations thereof may be used to signal any type of alarm level determined based on the cavitation probability detection. For example, any of these colors may appear on an indicator source, such as a light source, of the equipment or the equipment tag in a plant or processing information dashboard or screen. The green light may be configured to indicate no cavitation, the yellow light may be configured to indicate light cavitation detection, and the red light may be configured to indicate strong cavitation detection. For continuous improvement efforts to increase reliability and accuracy of cavitation detection, data retrieved from the sensors 110 may be transmitted to and retrieved by the node and/or server and may be used for analysis of one or more alert durations compared to the average time between failure analysis.

In another example, the different alerts may be configured to additionally or alternatively correspond to different alarm levels, such as via a character/number scheme. In some examples, the different alarm levels may include cavitation probability value. Without limitation, a first value, such as 0, may indicate no cavitation detection, a second value, such as 1, may indicate a low level cavitation detection, and a third value, such as 2, may indicate a high level cavitation detection. Each of these values may be generated and/or retrieved from any component of system 100, such as the server 140, and any color or combination of colors may be assigned by any component of system 100 to each of these values. For example, a plurality of alarm levels may be associated with one or more characters, numbers, and/or any combination thereof. Without limitation, a first alarm level may be associated with one or more characters, such as a letter abc or ABC or abC, a second alarm level may be associated with one or more numbers, such as a digit 1 or 12 or 123, and a third alarm level may be associated with a combination of a character and a number such as a1 or A12 or abC123. It is understood that other symbols, including but not limited to !@#$&*, and combinations thereof may be used to signal any type of alarm level determined based on the cavitation probability detection. For example, any of these character and number schemes may appear on an indicator source, such as a screen of the equipment or the equipment tag in a plant or processing information dashboard or screen. The letter may be configured to indicate no cavitation, the digit may be configured to indicate light cavitation detection, and the combination of the character and number may be configured to indicate strong cavitation detection. For continuous improvement efforts to increase reliability and accuracy of cavitation detection, data retrieved from the sensors 110 may be transmitted to and retrieved by PI data historians and may be used for analysis of one or more alert durations compared to the average time between failure analysis.

In some examples, each of the different alerts may be transmitted to one or more approved applications executing on devices, similar or different to application 155 executing on device 150. For example, the approval may be based on a whitelist such that access is only provided to one or more users associated with the one or more approved applications 155. In other example, the approval may be based on one or more parameters, such as credential or permission parameters. In this manner, only approved applications 155 with a verifiable credential or permission may be permitted to receive or access the one or more alerts. For example, an engineer associated with an application 155 executing on a device 150 may be configured to receive tor access the first type of alert if the application is whitelisted or if the engineer supplies an authenticated credential, such as a login input (user identification and/or password) or biometric input, and/or any combination thereof. For example, an operator associated with an application 155 executing on a device 150 may be configured to receive or access the second type of alert if the application is whitelisted or if the engineer supplies an authenticated credential, such as a login input (user identification and/or password) or biometric input, and/or any combination thereof. Thus, access or retrieval of this data is restricted, thereby facilitating secure implementations for handling the different types of alerts. Server 140 may be configured to authenticate the login input and/or biometric input received from application 155 executing on device 150.

The second pass may include evaluation of frequency specific amplitudes for the sensor baseline data. The second pass may utilize Fast Fourier Transform (FFT) for the evaluation of the change in amplitude of the frequency components. At normal flow rates, a baseline may be obtained to identify an amplitude at ½ Blade Pass Frequency (BPF) for pumps, and at a total amplitude change for the frequency range between BPF and the maximum usable frequency range for the sensor 110. As an example, a 5 vanned centrifugal pump, with a single volute, operating at 1,800 rpm has a BPF at 150 Hz. For this pump, one range of interest would be the acoustic amplitude of 70-80 Hz (margin is added to the range to account for speed variation, and FFT bucketing). A second range of interest would be from 150-20,000 Hz for an acoustic sensor with a range of 0-20 kHz. An alert margin may be set a fixed percentage above this baseline to be used as an alert of cavitation. For example, a first type of cavitation detection probability may be at 5 decibels rise, and a second type of cavitation detection probability may be at 10 decibels rise. In this manner, each type of cavitation detection probability would be associated with a different decibel rise.

The system 100 may include a network 120. In some examples, network 120 may be one or more of a wireless network, a wired network or any combination of wireless network and wired network, and may be configured to connect to any one of components of system 100. In some examples, network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 120 may include, without limitation, telephone lines, fiber optics, IEEE Ethernet 902.3, a wide area network, a wireless personal area network, a LAN, or a global network such as the Internet. In addition, network 120 may support an Internet network, a wireless communication network, a cellular network, or the like, or any combination thereof. Network 120 may further include one network, or any number of the exemplary types of networks mentioned above, operating as a stand-alone network or in cooperation with each other. Network 120 may utilize one or more protocols of one or more network elements to which they are communicatively coupled. Network 120 may translate to or from other protocols to one or more protocols of network devices. Although network 120 is depicted as a single network, it should be appreciated that according to one or more examples, network 120 may include a plurality of interconnected networks, such as, for example, the Internet, a service provider's network, a cable television network, corporate networks, such as credit card association networks, and home networks.

The system 100 may include a node 130. Node 130 may include any combination of a device and a database. The database may include a relational database, a non-relational database, or other database implementations, and any combination thereof, including a plurality of relational databases and non-relational databases. In some examples, the database may include a desktop database, a mobile database, or an in-memory database. Further, the database may be hosted internally by any component of system 100, or the database may be hosted externally to any component of system 100, such as by a server, by a cloud-based platform, or in any storage device.

For example, the node 130 may include an interface, such as a processing information interface. The interface may be configured to retrieve data from sensor 110. The sensor 110 may be configured to transmit data to interface. In some examples, sensor 110 may be configured to wirelessly transmit sensor data to interface. The sensor data from sensor 110 may include a raw format data type. The interface may be configured to transmit the sensor data from a raw format data type to a different format data type that is recognizable by server 140. In this manner, the interface may be configured to convert a first type of data to a second type of data. In other examples, the interface may be configured to transmit the sensor data to the server 140 in the same format that it received from the sensor 110. The sensor 110 may be configured to transmit raw data for regression to one or more servers 140, including but not limited to one or more cloud or cloud-based servers. In some examples, the one or more servers 140 may be configured to receive, transmit, and/or process the raw sensor data collected by the sensor for data regression. In other examples, an application 155 of device 150 may be configured to perform data regression. Since the transmission protocol speed may impact the battery life of the sensor 110, this factor may be taken into consideration in determining whether the data regression is performed by the one or more servers 140 or the application 155 of the device 150.

The system 100 may include a server 140. The server 140 may include one or more processors coupled to memory. Server 140 may be configured as a central system, server or platform to control and call various data at different times to execute a plurality of workflow actions. Server 140 may be configured to connect to any number of components of system 100. For example, a server 140 may be in data communication with the client application 150 via one or more networks 120.

The server 140 may be configured to receive the sensor data from the node 130. For example, the server 140 may be configured to receive the sensor data converted by the interface. In some examples, the server 140 may be configured to receive the sensor data from the node 130 in a raw format. In this example, the server 140 may be configured to convert the raw format of the sensor data to another format recognizable by server 140.

The server 140 may be configured to respond to one or more requests for the sensor data from an application 155 including instructions for execution on a client device 150. For example, at least one of the requests may include a query for the sensor data over a period of 7 days for a given pump. Responsive to the query, the server 140 may be configured to transmit, via one or more responses, the requested sensor data over the period of 7 days for the given pump to the application 155 of client device 150.

In some examples, the server 140 may be configured to transmit one or more alerts. For example, the server 140 may be configured to transmit a first alert for the first cavitation detection probability. The server 140 may be configured to transmit a second alert for the second cavitation detection probability.

The system 100 may include a client device 150. For example, the client device 150 may be in communication with any components of system 100. For example, client device 150 may execute one or more applications, such as application 155, that enable, for example, network and/or data communications with one or more components of system 100 and transmit and/or receive data. The client device 150 may include one or more processors coupled to memory. For example, the client device 150 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The client device 150 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 150 may include processing circuitry and may contain additional components, including processors, memories, error and parity/CRC checkers, data encoders, anticollision algorithms, controllers, command decoders, security primitives and tamperproofing hardware, as necessary to perform the functions described herein. The client device 150 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

The application 155 of client device 150 may be configured to transmit one or more requests for the sensor data from the server 140. For example, at least one of the requests may include a query for the sensor data over a period of 7 days for a given pump. Responsive to the query, the application 155 of client device 150 may be configured to receive, via one or more responses, the requested sensor data over the period of 7 days for the given pump from server 140.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the node 130, server 140, client device 150, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

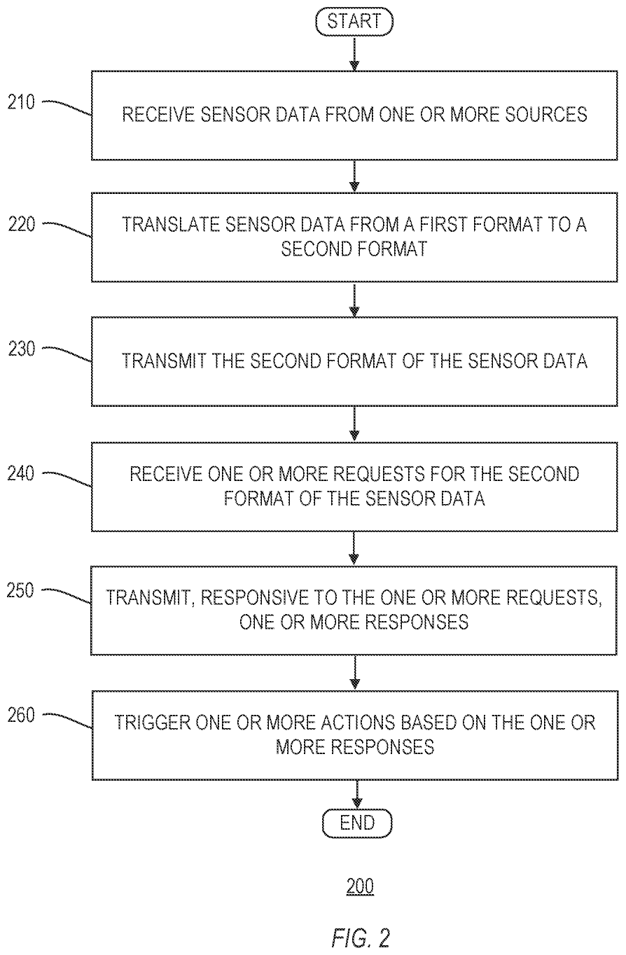

FIG. 2 depicts a method 200 of cavitation detection. FIG. 2 may reference same or similar components of system 100 of FIG. 1.

At block 210, the method 200 may include receiving sensor data from one or more data sources. For example, a node may include an interface, such as a processing information interface, and may be configured to retrieve data from a sensor, such as a wireless acoustic sensor. The sensor may be configured to transmit data to the interface. In some examples, the sensor may be configured to wirelessly transmit sensor data to the interface.

The sensor may be mounted to equipment. For example, the sensor may be installed on a pump. For example, the sensor may be installed on one or more pumps, such as a centrifugal pump, since these pumps make up the largest volume of pumps in the industry and are the most prone to cavitation damage. The sensor may also be installed on one or more valves, such as a control valve since these valves make up the next largest type of equipment prone to cavitation damage, as a regulating valve may cause extremely low pressures in its internals thereby causing damage to those internals and the piping just downstream of the valve. The sensor may be configured to record a sound waveform. In some examples, the sensor may be configured to record the sound waveform on a predetermined basis. For example, the sensor may be configured to record the waveform on a periodic basis. The sensor may be configured to report on each recording of the sound waveform. The sensor may be configured to report on a specified time period that exceeds the time between each reading. The sensor may be configured to report on the specified time period unless cavitation is detected, at which point the sensor may be configured to report immediately in real-time. The sensor data may be analyzed to determine one or more automated corrective actions resulting from the detection of probability of cavitation. For example, such corrective actions may be taken by the system include validating that cavitation is actually taking place, via the systems and methods described herein, and rectifying the cavitation by increasing the flow rate, increasing the suction pressure, increasing the discharge pressure, and/or any combination thereof. These adjustments may serve as the nexus between the corrective action and cavitation detection probability, and depend on the type of pump or valve at issue. Additionally, responsive to the detection of probability of cavitation, one or more backup pumps and/or valves may be configured to control, via machine learning by the system, redirect flow, increase flow, discharge pressure, and/or any combination thereof.

The sensor may be magnetically coupled to the equipment. For example, a magnet may be secured, including but not limited to via one or more screws, a portion of the sensor, such as a base portion of the sensor. Consequently, this arrangement may enable the sensor to be positioned on any ferromagnetic type of equipment, such as motor, pump housing, and/or piping. The placement of the sensor may be on a surface of the equipment, such as on a surface in proximity to the inlet of the pump. Other sensor coupling techniques may be used, such as epoxy coupling.

Moreover, the sensor may be configured to remove ambient noise. In some examples, noise may be removed based on readings from two sensors, and subtracting one of the readings by one of the sensors from the reading by the other sensor. In other examples, noise may be removed based on a reading recorded from a predetermined time when the equipment is known and confirmed to be operating in a healthy state, and then subtracted from one or more future readings.

The sound waveform may be processed via a plurality of passes. A first pass may be selected from the plurality of passes and may be associated with decibel level. A second pass may be selected from the plurality of passes and may be associated with frequency amplitude.

The first pass may include evaluation of the overall decibel reading at normal flow rates for the sensor baseline data. In some examples, normal flow rates may be those congruent with the design flow rate and pressures using the design fluid. The sensor baseline data would also be confirmed by the node, server, or application of the device configured to analyze the acoustics of cavitation in the equipment.

An alert margin may be set a fixed percentage above this baseline to be used as an alert of cavitation. For example, a first type of cavitation detection probability, such as low cavitation detection probability, may be at 5 decibels rise, and a second type of cavitation detection probability, such as high cavitation detection probability, may be at 10 decibels rise. Accordingly, each type of cavitation detection probability is be associated with a different threshold decibel rise.

Moreover, each type of cavitation detection probability, for example, low cavitation detection probability may trigger a first type of alert whereas the second or high cavitation detection probability may trigger a second type of alert. Different alerts may be generated upon determination of the cavitation detection probability. The different alerts may be configured to correspond to different alarm levels, such as via a color coded scheme, a character/number scheme, and/or any combination thereof. In some examples, the different alarm levels may include cavitation probability value. Without limitation, a first value, such as 0, may indicate no cavitation detection, a second value, such as 1, may indicate a low level cavitation detection, and a third value, such as 2, may indicate a high level cavitation detection. Each of these values may be generated and/or retrieved from any component of the system, such as the server, and any color or combination of colors may be assigned by any component of system to each of these values. For example, a plurality of alarm levels may be associated with one or more colors. Without limitation, a first alarm level may be associated with a first color, such as green, a second alarm level may be associated with a second color, such as yellow, and a third alarm level may be associated with a third color, such as red. It is understood that other colors and combinations thereof may be used to signal any type of alarm level determined based on the cavitation probability detection. For example, any of these colors may appear on an indicator source, such as a light source, of the equipment or the equipment tag in a plant or processing information dashboard or screen. The green light may be configured to indicate no cavitation, the yellow light may be configured to indicate light cavitation detection, and the red light may be configured to indicate strong cavitation detection. For continuous improvement efforts to increase reliability and accuracy of cavitation detection, data retrieved from the sensors may be transmitted to and retrieved by the node and/or server and may be used for analysis of one or more alert durations compared to the average time between failure analysis.

In another example, the different alerts may be configured to additionally or alternatively correspond to different alarm levels, such as via a character/number scheme. In some examples, the different alarm levels may include cavitation probability value. Without limitation, a first value, such as 0, may indicate no cavitation detection, a second value, such as 1, may indicate a low level cavitation detection, and a third value, such as 2, may indicate a high level cavitation detection. Each of these values may be generated and/or retrieved from any component of system, such as the server, and any color or combination of colors may be assigned by any component of system to each of these values. For example, a plurality of alarm levels may be associated with one or more characters, numbers, and/or any combination thereof. Without limitation, a first alarm level may be associated with one or more characters, such as a letter abc or ABC or abC, a second alarm level may be associated with one or more numbers, such as a digit 1 or 12 or 123, and a third alarm level may be associated with a combination of a character and a number such as a1 or A12 or abC123. It is understood that other symbols, including but not limited to !@#$&*, and combinations thereof may be used to signal any type of alarm level determined based on the cavitation probability detection. For example, any of these character and number schemes may appear on an indicator source, such as a screen of the equipment or the equipment tag in a plant or processing information dashboard or screen. The letter may be configured to indicate no cavitation, the digit may be configured to indicate light cavitation detection, and the combination of the character and number may be configured to indicate strong cavitation detection. For continuous improvement efforts to increase reliability and accuracy of cavitation detection, data retrieved from the sensors may be transmitted to and retrieved by PI data historians and may be used for analysis of one or more alert durations compared to the average time between failure analysis.

In some examples, each of the different alerts may be transmitted to one or more approved applications executing on devices, similar or different to application executing on device. For example, the approval may be based on a whitelist such that access is only provided to one or more users associated with the one or more approved applications. In other example, the approval may be based on one or more parameters, such as credential or permission parameters. In this manner, only approved applications with a verifiable credential or permission may be permitted to receive or access the one or more alerts. For example, an engineer associated with an application executing on a device may be configured to receive tor access the first type of alert if the application is whitelisted or if the engineer supplies an authenticated credential, such as a login input (user identification and/or password) or biometric input, and/or any combination thereof. For example, an operator associated with an application executing on a device may be configured to receive or access the second type of alert if the application is whitelisted or if the engineer supplies an authenticated credential, such as a login input (user identification and/or password) or biometric input, and/or any combination thereof. Thus, access or retrieval of this data is restricted, thereby facilitating secure implementations for handling the different types of alerts. Server may be configured to authenticate the login input and/or biometric input received from application executing on device.

The second pass may include evaluation of frequency specific amplitudes for the sensor baseline data. The second pass may utilize Fast Fourier Transform (FFT) for the evaluation of the change in amplitude of the frequency components. At normal flow rates, a baseline may be obtained to identify an amplitude at ½ Blade Pass Frequency (BPF) for pumps, and at a total amplitude change for the frequency range between BPF and the maximum usable frequency range for the sensor. As an example, a 5 vanned centrifugal pump, with a single volute, operating at 1,800 rpm has a BPF at 150 Hz. For this pump, one range of interest would be the acoustic amplitude of 70-80 Hz (margin is added to the range to account for speed variation, and FFT bucketing). A second range of interest would be from 150-20,000 Hz for an acoustic sensor with a range of 0-20 kHz. An alert margin may be set a fixed percentage above this baseline to be used as an alert of cavitation. For example, a first type of cavitation detection probability may be at 5 decibels rise, and a second type of cavitation detection probability may be at 10 decibels rise. In this manner, each type of cavitation detection probability would be associated with a different decibel rise.

At block 220, the method 200 may include translating a first format of the sensor data to a second format of the sensor data. The sensor data from the sensor may include a raw format data type. The interface may be configured to transmit the sensor data from a raw format data type to a different format data type that is recognizable by a server. In this manner, the interface may be configured to convert a first type of data to a second type of data. In other examples, the interface may be configured to transmit the sensor data to the server in the same format that it received from the sensor. The sensor may be configured to transmit raw data for regression to one or more servers, including but not limited to one or more cloud or cloud-based servers. In some examples, the one or more servers may be configured to receive, transmit, and/or process the raw sensor data collected by the sensor for data regression. In other examples, an application of device may be configured to perform data regression. Since the transmission protocol speed may impact the battery life of the sensor, this factor may be taken into consideration in determining whether the data regression is performed by the one or more servers or the application of the device.

At block 230, the method 200 may include transmitting the second format of the sensor data.

At block 240, the method 200 may include receiving one or more requests for the second format of the sensor data. For example, the server may include one or more processors coupled to memory. The server may be configured as a central system, server or platform to control and call various data at different times to execute a plurality of workflow actions. The server may be configured to connect to any number of components of the system. For example, a server may be in data communication with the client application of a client device via one or more networks.

The server may be configured to receive the sensor data from the node. For example, the server may be configured to receive the sensor data converted by the interface. In some examples, the server may be configured to receive the sensor data from the node in a raw format. In this example, the server may be configured to convert the raw format of the sensor data to another format recognizable by server.

At block 250, the method 200 may include transmitting one or more responses that are responsive to the one or more requests. For example, the server may be configured to respond to one or more requests for the sensor data from an application including instructions for execution on a client device. For example, at least one of the requests may include a query for the sensor data over a period of 7 days for a given pump. Responsive to the query, the server may be configured to transmit, via one or more responses, the requested sensor data over the period of 7 days for the given pump to the application of client device.

At block 260, the method 200 may include triggering one or more actions based on the one or more responses. For example, the server may be configured to transmit one or more alerts. For example, the server may be configured to transmit a first alert for the first cavitation detection probability. The server may be configured to transmit a second alert for the second cavitation detection probability. Without limitation, each type of cavitation detection probability, for example, low cavitation detection probability may trigger a first type of alert whereas the second or high cavitation detection probability may trigger a second type of alert. Different alerts may be generated upon determination of the cavitation detection probability.

FIG. 3 illustrates a block diagram of a cavitation sensor 300 according to an exemplary embodiment. Although FIG. 3 illustrates single instances of components of sensor 300, sensor 300 may include any number of components, and may be fully operational despite the absence or inclusion of any one of these components. The sensor 300 may reference the same or similar functionality of sensor 110 of FIG. 1

The sensor 300 may include a housing 310. Housing 310 may be configured to house an antenna 320, a transmitter/receiver 330, memory 340, processor 350, acoustic sensor or microphone 360, and an accelerometer 370. The sensor housing 310 may be coupled to a sensor mount 380 so as to mount the sensor to one or more surfaces, such as a cavitation source surface 390, including but not limited to a pump and/or a valve or equipment connected thereon. The sensor 300 may be mounted to equipment via magnetic coupling or epoxy coupling, as previously explained. The sensor 300 may be powered by a battery (not shown), which as mentioned above, affects the transmission protocol speed and data regression source.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that include an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

What is claimed is:

1. A cavitation detection system, comprising:
one or more processors configured to:
receive sensor data from one or more data sources;
translate a first format of the sensor data to a second format of the sensor data;
transmit the second format of the sensor data;
receive one or more requests for the second format of the sensor data;
transmit one or more responses that are responsive to the one or more requests, the one or more responses comprising a level of cavitation detection based on decibel and frequency measurements of the sensor data; and
trigger one or more actions based on the one or more responses.

2. The cavitation detection system of claim 1, wherein the one or more data sources are configured to perform one or more measurements on a predetermined time range.

3. The cavitation detection system of claim 1, wherein the one or more data sources are configured to evaluate the sensor data based on a plurality of passes.

4. The cavitation detection system of claim 3, wherein at least one pass comprises evaluating overall decibel reading at one or more flow rates of the sensor data.

5. The cavitation detection system of claim 4, wherein the at least one pass comprises determining a first type of cavitation detection probability at a first decibel rise, and a second type of cavitation detection probability at a second decibel rise.

6. The cavitation detection system of claim 5, wherein each type of cavitation detection probability triggers a different alert.

7. The cavitation detection system of claim 6, wherein a first alert is based on a visual scheme associated with one or more color indicators.

8. The cavitation detection system of claim 6, wherein a second alert is based on a character scheme associated with one or more indicators.

9. The cavitation detection system of claim 3, wherein at least one pass comprises evaluating a change in amplitude of frequency at one or more flow rates of the sensor data.

10. The cavitation detection system of claim 9, wherein an amplitude at ½ blade pass frequency is identified from a baseline of the sensor data.

11. A method of cavitation detection, comprising:
receiving sensor data from one or more data sources;
translating a first format of the sensor data to a second format of the sensor data;
transmitting the second format of the sensor data;
receiving one or more requests for the second format of the sensor data;
transmitting one or more responses that are responsive to the one or more requests; and
triggering one or more actions based on the one or more responses.

12. The method of claim 11, wherein the one or more data sources are configured to perform one or more measurements on a predetermined time range.

13. The method of claim 11, further comprising evaluating the sensor data based on a plurality of passes.

14. The method of claim 13, wherein at least one pass comprises evaluating overall decibel reading at one or more flow rates of the sensor data.

15. The method of claim 14, wherein the at least one pass comprises determining a first type of cavitation detection probability at a first decibel rise, and a second type of cavitation detection probability at a second decibel rise.

16. The method of claim 15, wherein each type of cavitation detection probability triggers a different alert.

17. The method of claim 16, wherein a first alert is based on a visual scheme associated with one or more color indicators.

18. The method of claim 16, wherein a second alert is based on a character scheme associated with one or more indicators.

19. The method of claim 13, wherein at least one pass comprises evaluating a change in amplitude of frequency at one or more flow rates of the sensor data.

20. The method of claim 19, wherein an amplitude at ½ blade pass frequency is identified from a baseline of the sensor data.

21. A method of cavitation detection, comprising:
receiving sensor data from one or more sensors;
determining one or more levels of cavitation by evaluating the sensor data based on a plurality of passes, the plurality of passes including a decibel evaluation and a frequency evaluation at one or more flow rates of the sensor data;
generating one or more alerts based on the one or more levels of cavitation; and
transmitting, based on one or more requests, one or more responses including the one or more alerts and a converted format of the sensor data.
